(19) United States
(12) Patent Application Publication
(10) Pub. No.: US 2003/0156229 A1
(43) Pub. Date: Aug. 21, 2003

(54) Method and apparatus for automatically adjusting the raster in projection television receivers

(75) Inventors: Zaher A. Samman, Knoxville, TN (US); Lane H. Whiteside, Knoxville, TN (US)

Correspondence Address: PHILIPS INTELLECTUAL PROPERTY & STANDARDS, P.O. BOX 3001, BRIARCLIFF MANOR, NY, 10510, US

(73) Assignee: KONINLIJKE PHILIPS ELECTRONICS N.V.

(21) Appl. No.: 10/080,202

(22) Filed: Feb. 20, 2002

(51) Int. Cl. H04N 3/223

(52) U.S. Cl. 348/745; 348/189

(57) ABSTRACT

A method and apparatus for automatically adjusting the raster geometry of a rear projection television receiver detects the outputs of optical sensor placed on the display screen above, below and on both sides of a viewing area of said display screen, and based on the outputs of these sensors in response to test raster patterns displayed on the display screen, adjusts the centering, width, height and linearity of the raster being projected by the projection television receiver.

### BACKGROUND OF THE INVENTION

1. Field of the Invention

The subject invention relates to rear projection television receivers, and more particularly, to adjusting the raster geometry therein.

2. Description of the Related Art

With the advent of home theater systems, it has become increasingly desirable to have a television receiver with a large display. Standard direct view television receivers have a display which is typically a glass cathode ray tube (CRT). Due to weight and cost considerations, CRT's are ordinarily limited to a maximum size of 40 inches (diagonally measured). While this size is considerable, it is regarded as a minimum for a home theater system. Larger size displays are thus provided by projection television receivers where the image is formed in a projection arrangement and is then projected onto a remote screen.

There are basically two types of projection television receivers, i.e., front projection, in which the projection arrangement is physically separated from the display screen, and rear projection, in which the projection arrangement and the display screen are housed within a cabinet. In either case, the projection arrangement typically includes three monochrome projectors for forming images of the three primary colors—red, green and blue. These images are then converged at the display screen.

FIG. 1 shows a plan view of the inside of a typical rear projection television receiver 10 in which a projection arrangement 12 forms an image which is focused by a lens arrangement 14. This image is reflected off of an internal mirror 16 onto a display screen 18. As shown in FIG. 2, the projection arrangement 12 is preferably formed by three projectors 12.1, 12.2 and 12.3, which may be cathode ray tubes, the images therefrom being focused by three respective lenses 14.1, 14.2 and 14.3 onto the display screen 18. As should be apparent from viewing FIG. 2, only one of the projectors, i.e., projector 12.2, is optimally positioned with respect to the screen 18. As such, the images from the other projectors 12.1 and 12.3 are adjusted such that they converge with the image from the projector 12.2. While this convergence may be performed visually by a user of the projection television receiver, systems have been developed for automating this process.

U.S. Pat. No. 4,857,998 to Tsujihara et al. discloses such a system in which optical sensors are positioned at the left-center and bottom-center of the display screen. A test pattern consisting of a horizontal line for the left-center sensor and a vertical line for the bottom sensor is displayed for each projection tube 10. The convergence for each projection tube is adjusted until the sensors detect the proper positioning of the test pattern.

U.S. Pat. No. 5,898,465 to Kawashima et al. discloses another system for automatically adjusting the convergence in a projection television receiver in which, as compared with Tsujihara et al., a top-center sensor and a right-center sensor is included in addition to the left-center and bottom-center sensors. With regard to each CRT, two test patterns are displayed and the resulting signals from each sensor are compared. The resulting error signals are used to effect convergence.

While both Tsujihara et al. and Kawashima et al. adequately address the problem of converging the rasters from the three CRTs, none of these references are concerned with the geometry of the generated raster.

### SUMMARY OF THE INVENTION

It is an object of the invention to provide a method and apparatus for automatically adjusting the geometry and positioning of a raster in a projection television receiver. This object is achieved in a method for adjusting the centering of a raster in a rear projection television receiver, said method comprises the steps mounting optical sensors on the inside of the rear projection television receiver outside of a display screen at both lateral sides of the display screen; displaying a test pattern consisting of a raster center adjust pattern; and adjusting the centering of the raster based on the outputs of the optical sensors located on the lateral sides of the display screen. As such, the raster display from the CRTs is assured to be centered on the display screen.

In a particular embodiment of such a method, the adjusting step comprises setting a centering control at a one extreme value; measuring the output voltages generated by the lateral optical sensors; calculating the centering error by determining the absolute value of the difference between the output it voltages; incrementally adjusting the centering control away from said one extreme value; and repeating said measuring, calculating and incrementally adjusting steps until the centering error is at a minimum value. This allows the raster to be iteratively moved from one side to, eventually, the center of the display screen.

The object of the invention is also achieved in a method for adjusting a width of a raster in a rear projection television receiver, said method comprising the steps mounting optical sensors on the inside of the rear projection television receiver outside of a display screen at both lateral sides of the display screen; displaying a test pattern consisting of a raster projection pattern; and adjusting the width of the raster based on the outputs of the optical sensors located on the lateral sides of the display screen. This method assures that the raster always has the appropriate width for the display.

In a particular embodiment of such a method, the adjusting step comprises setting a width control for the raster to a maximum value; measuring the output voltages generated by the lateral optical sensors; calculating the width error by determining the sum of the output voltages; incrementally decreasing the width control; and repeating said measuring, calculating and incrementally decreasing steps until the width error equals a minimum value. In this embodiment, the raster is adjusted to its widest amount and is then iteratively reduced in width until it is at the proper width.

The object of the invention is also achieved in a method for adjusting a linearity of a raster in a rear projection television receiver, said method comprising the steps mounting optical sensors on the inside of the rear projection television receiver outside of a display screen at the top and bottom of the display screen; displaying a test pattern consisting of a raster projection pattern; and adjusting the linearity of the raster based on the outputs of the optical sensors located at the top and bottom of the display screen. This method then assures that the raster is vertically centered on the display screen.

In a particular embodiment of this method, the adjusting step comprises setting a linearity control to one extreme value; measuring the output voltages generated by the top and bottom optical sensors; calculating the linearity error by determining the absolute value of the difference of the output voltages; incrementally adjusting the linearity control away from said one extreme value; and repeating said measuring, calculating and incrementally adjusting steps until the linearity error equals a minimum value.

The object of the invention is further achieved in a method for adjusting a height of a raster in a rear projection television receiver, said method comprising the steps mounting optical sensors on the inside of the rear projection television receiver outside of a display screen at the top and bottom of the display screen; displaying a test pattern consisting of a raster projection pattern; and adjusting the height of the raster based on the outputs of the optical sensors located at the top and bottom of the display screen. With this method, it is assured that the height of the raster is at the appropriate size.

In a particular embodiment of this method, the adjusting step comprises setting a height control for the raster to a maximum value; measuring the output voltages generated by the top and bottom optical sensors; calculating the height error by determining the sum of the output voltages; incrementally decreasing the height control; and repeating said measuring, calculating and incrementally decreasing steps until the height error equals a minimum value.

Finally, the object of the invention is achieved in an arrangement for adjusting a raster geometry in a rear projection television receiver, said rear projection television receiver having an input for receiving television signals, a video processing circuit for processing said received television signals and for forming color video signals and deflection control signals, color video signal projectors for projecting light signals corresponding to said color video signals in dependence on said deflection signals, and a display screen on which said light signals are projected, wherein said video signal processing circuit includes control input means for receiving control signals for controlling a centering, height, width and linearity of a raster formed by at least one of said color video signal projectors, characterized in that said arrangement comprises a pattern generator coupled to the video signal processing circuit for applying selected test patterns to said video signal processing circuit, said test patterns including a center adjust pattern and a raster projection pattern; a plurality of optical sensors mounted inside of the rear projection television receiver outside of the display screen at both lateral sides and above and below the display screen; a sensor output selector for selecting an output signal from one of said plurality of optical sensors; an analog-to-digital converter for digitally converting the selected optical sensor output signal; a controller having an input coupled to receive the digitally converted sensor output signal, a first output coupled to said sensor output selector for selecting one of the sensor output signals, a second output coupled to the video signal processing circuit for causing the video signal processing circuit to process the test pattern from the pattern generator, a third output coupled to the pattern generator for selecting one of the test patterns, and fourth outputs coupled to the control input means of the video signal processing circuit for controlling the centering, height, width and linearity of the raster generated by said one color video signal projector, wherein said controller performs the following functions sets the height and width controls for the raster to respective maximum values; displays a first test pattern consisting of a raster projection pattern; measures and storing the maximum output from said optical sensors; displays a second test pattern consisting of a center adjust pattern; adjusts the centering of the raster based on the outputs of the optical sensors located on the lateral sides of the display screen; displays the first test pattern; adjusts the width of the raster based on the outputs of the optical sensors located on the lateral sides of the display screen; adjusts the height of the raster based on the outputs of the optical sensors located above and below the display screen; adjusts the linearity of the raster based on the outputs of the optical sensors located above and below the display screen; and re-adjusts the height of the raster based on the outputs of the optical sensors located above and below the display screen.

### BRIEF DESCRIPTION OF THE DRAWINGS

With the above and additional objects and advantages in mind as will hereinafter appear, the invention will be described with reference to the accompanying drawings, in which:

FIG. 1 is a plan view showing a typical rear projection television receiver;

FIG. 2 illustrates the relationship between the three CRT's in the rear projection television shown in FIG. 1;

FIG. 3 shows a block schematic diagram of the rear projection television of FIG. 1 incorporating the subject invention;

FIG. 4A shows a illustration of the inside of the rear projection television receiver in which the raster projection pattern is at its maximum size, while FIG. 4B shows an illustration where the raster projection pattern is at its optimum size;

FIG. 5A shows an illustration of the inside of the rear projection television receiver in which a raster center adjust pattern is biased to one side, while FIG. 5B shows an illustration where the raster center adjust pattern is properly located;

FIG. 6 shows a flowchart of the process for adjusting the raster geometry of the rear projection television receiver; and

FIG. 7A shows a flowchart of a subroutine for adjusting the centering of the raster center adjust pattern for use in the flowchart of FIG. 6, FIG. 7B shows a flowchart of a subroutine for adjusting the width of the raster projection pattern, FIG. 7C shows a flowchart of a subroutine for adjusting the height of the raster projection pattern, and FIG. 7D shows a flowchart for adjusting the linearity of the raster projection pattern.

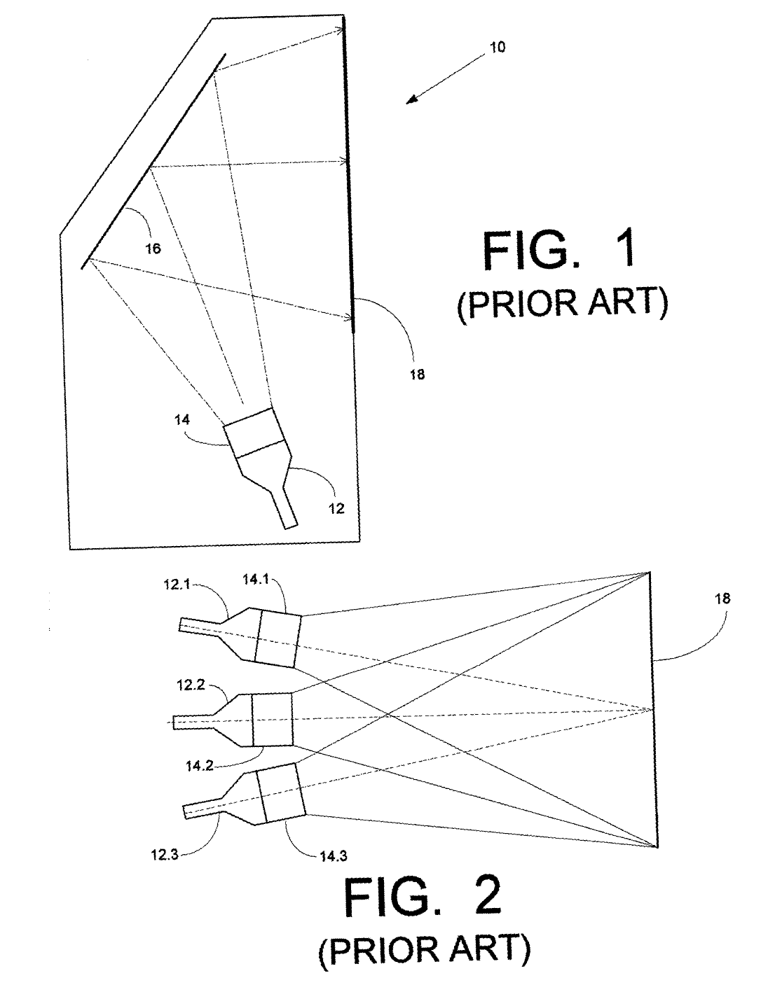

### DESCRIPTION OF THE PREFERRED EMBODIMENTS

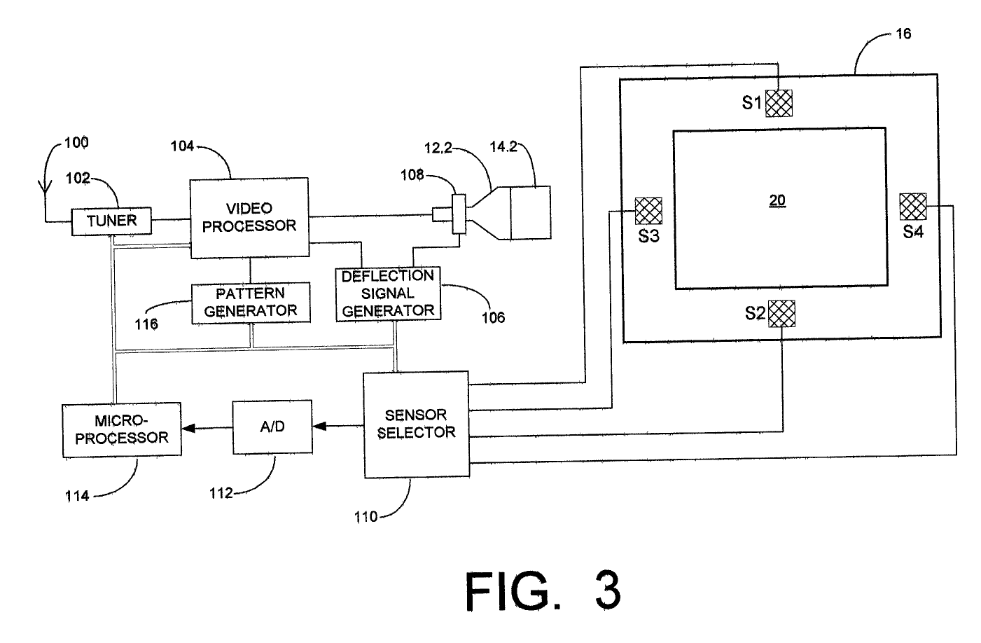

As shown in FIG. 3, a typical rear projection television receiver includes a source of television signals, e.g., antenna 100. The antenna 100 is connected to a tuner 102 which tunes to a particular television signal. This television signal is applied to a video signal processing circuit 104 which generates synchronization signal for application to a deflection signal generator 106, and separate color video signals for the three primary colors, red, green and blue for application to a cathode ray tube. For simplicity, only the green cathode ray tube 12.2 is shown. The deflection signal generator 106 generates deflection signals for a deflection unit 108 mounted on the cathode ray tube 12.2. The resulting light from the cathode ray tube 12.2 is focused by the lens 14.2 and impinges the display screen 16. The display screen 16 has a viewable area 20 which is visible to a user of the rear projection television receiver. The deflection signal generator 106 may have separate outputs (not shown) for the red and green cathode ray tubes (not shown). Alternatively, separate deflection signal generators may be used for the red and green cathode ray tubes. As is known in the art, the deflection signal generator includes controls inputs for controlling the centering, width, height and linearity of the resulting raster.

In order to adjust the raster geometry, the rear projection television receiver further includes optical sensors S1, S2, S3 and S4 mount on the display screen 16 outside of the viewable area 20. The optical sensors are located at the top-center, bottom-center, left-center and right-center of the viewable area 20. While located outside of the viewable area, these optical sensors are nonetheless capable of being illuminated by light from the cathode ray tube 12.2. The outputs from the optical sensors are connected to a sensor selector 110 which, in response to a control signal, applies one of the sensor output signals to an analog-to-digital converter 112. The digitized sensor output signal is then applied to a microprocessor 114.

The microprocessor 114 controls the tuning by the tuner 102 and the video processing performed in the video signal processing circuit 104. In addition, the microprocessor 114 applies a control signal to a pattern generator 116 for generating one of two video patterns, and instructs the video signal processing circuit 104 to display the selected video pattern when a raster adjustment is desired. To adjust the raster, the microprocessor 114 applies the appropriate control signals to the control inputs of the deflection signal generator 106.

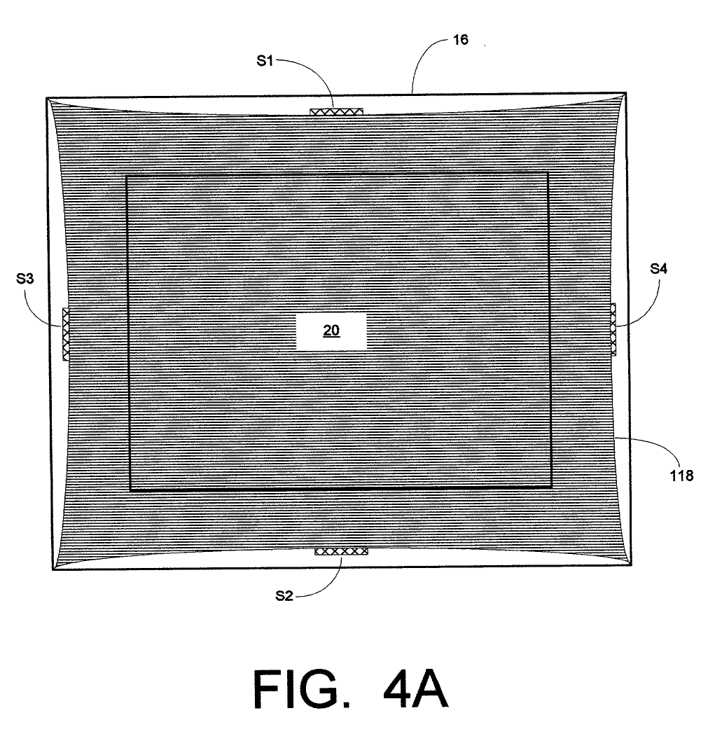

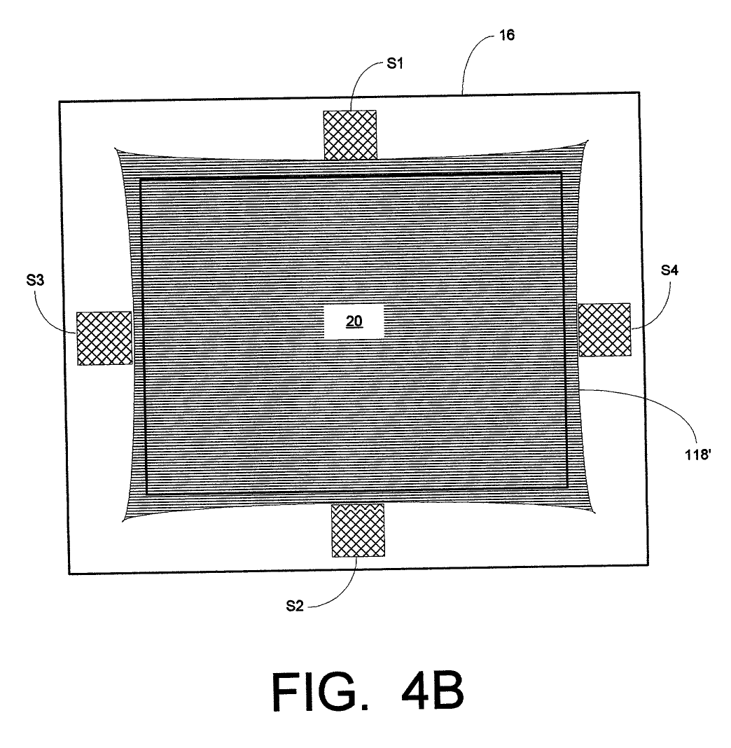

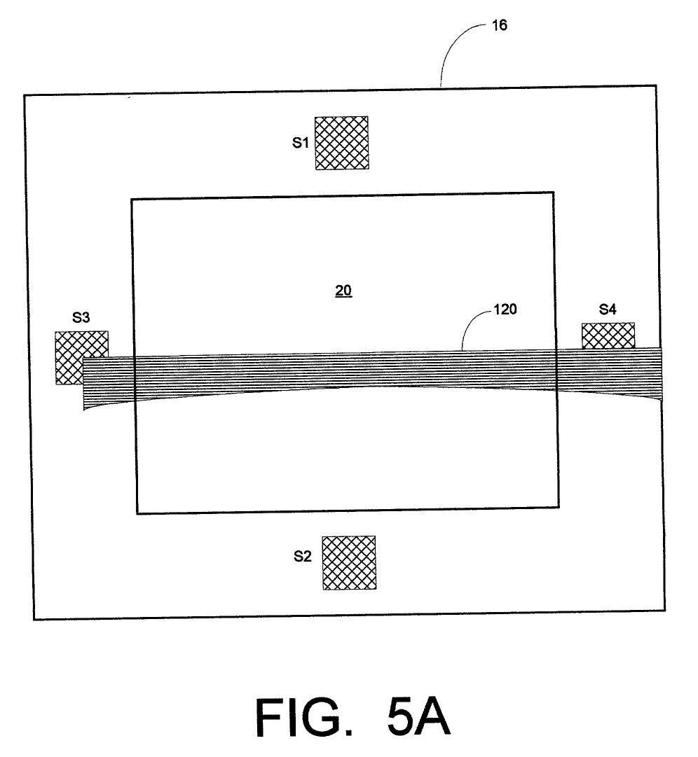

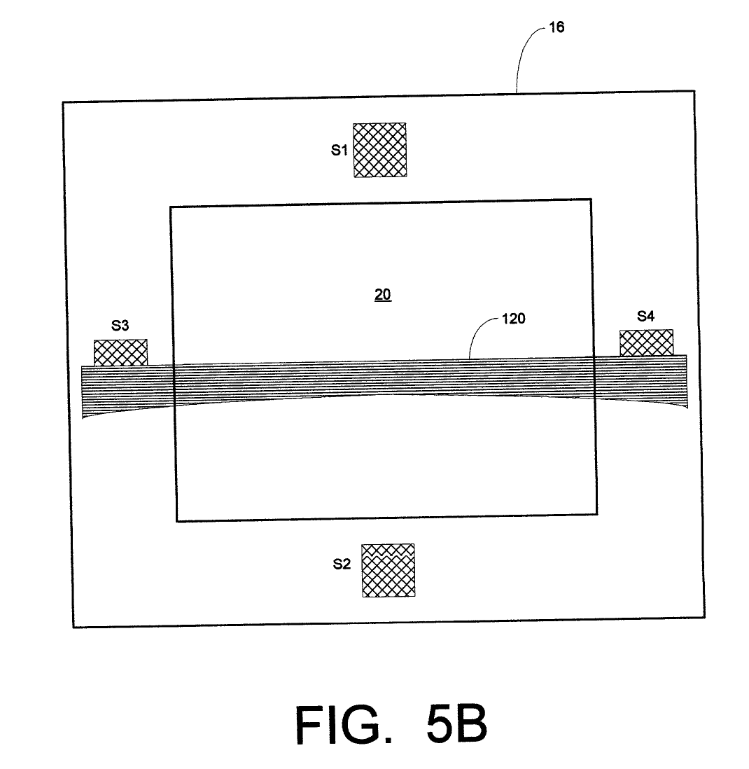

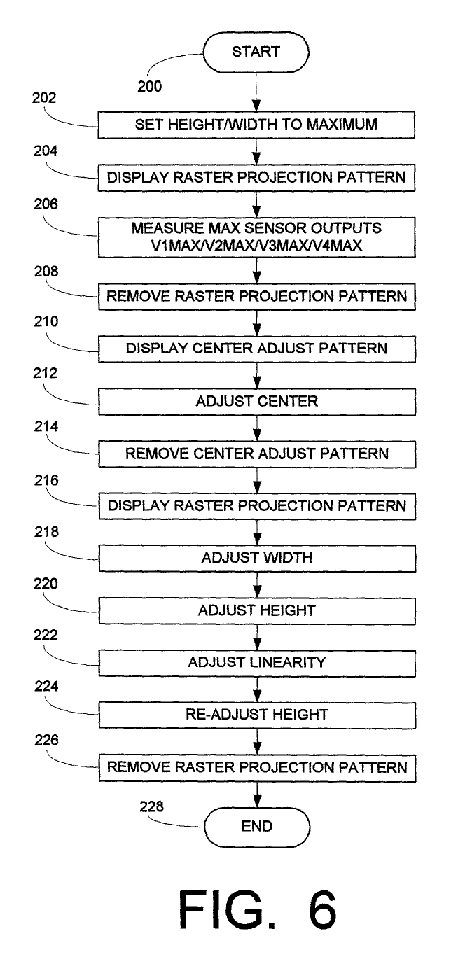

FIG. 6 shows a flowchart of the process performed by the microprocessor 114 in adjusting the raster. When the user of the projection television receiver selects “raster adjustment”, for example, from an On-Screen menu option, the process is started at step 200. At step 202, the microprocessor 114 sets the height and width controls for the deflection signal generator 106 at their respective maximum levels. At step 204, the microprocessor 114 instructs the pattern generator 116 to generate the raster projection pattern 118 shown, for example, in FIG. 4A. The microprocessor 114, in step 206 measures the resultant maximum sensor outputs V1MAX, V2MAX, V3MAX, V4MAX by causing the sensor selector 110 to sequentially switch to each of the sensors S1, S2, S3 and S4, and by then measuring and storing the respective outputs from the A/D converter 112. At step 208, the microprocessor 114 then instructs the pattern generator 116 to remove the raster projection pattern 118 and, in step 210, to apply the center adjust pattern 120 as shown, for example, in FIG. 5A. At step 212, the microprocessor 114 then adjusts the centering of the projection television receiver. At step 214, the microprocessor instructs the pattern generator 116 to remove the center adjust pattern 120 and, at step 216, to re-apply the raster projection pattern 118. The microprocessor 114 then adjusts the width (step 218), the height (step 220) and the linearity (step 222). It should be noted that in adjusting the linearity, the height of the raster may be compromised. As such, the height adjust sub-routine is repeated at step 224. At step 226, the microprocessor 114 then instructs the pattern generator 116 to remove the raster projection pattern, and the process is terminated at step 228.

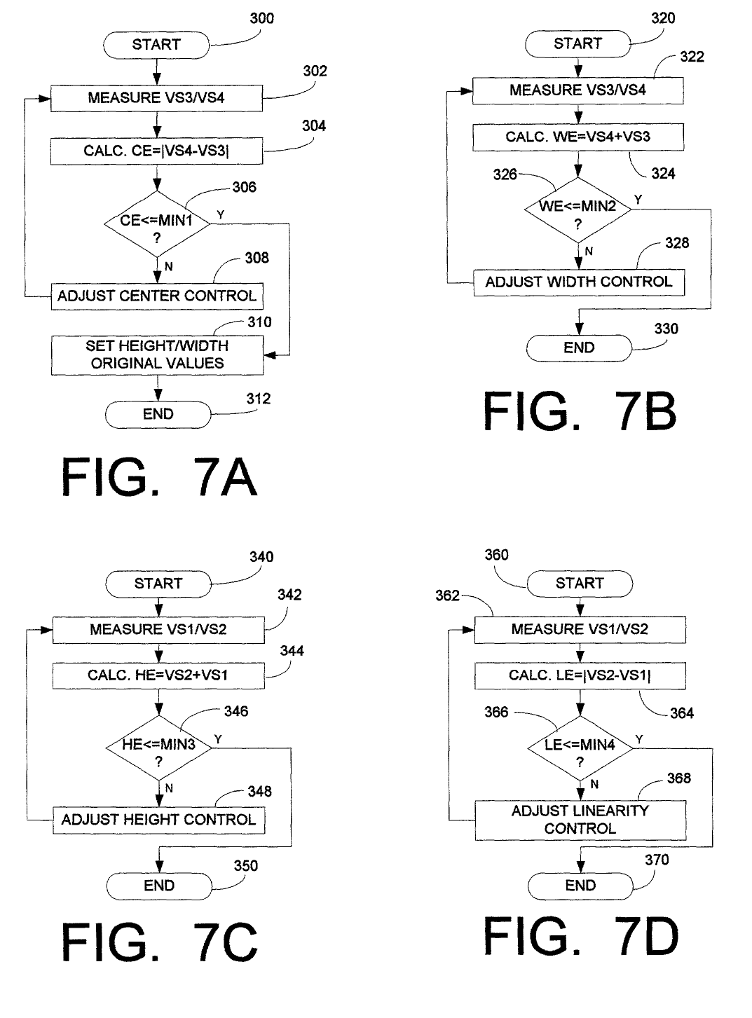

FIGS. 7A-7D show flowcharts of the sub-routines for adjusting the centering, the width, the height and the linearity. For controlling the centering, step 212 of FIG. 6, as shown in FIG. 7A, the center control sub-routine is started at 300. At step 302, the microprocessor 114 measures the output voltages VS3 and VS4 of sensors S3 and S4, respectively, by controlling the sensor selector 110. The microprocessor 114 then calculates the centering error CE using the formula: CE=|VS4−VS3|. If CE is not equal to (or less than) a first predetermined minimum value MIN1, the microprocessor 114 adjusts the control signal for centering applied to the deflection signal generator 106. Steps 302, 304, 306 and 308 are then repeatedly performed until CE is equal to or less than MIN1. Then, at step 310, the microprocessor 114 re-sets the height and width controls back to their original values. This sub-routine then ends at step 312.

For controlling the width, step 218 of FIG. 6, as shown in FIG. 7B, the width control sub-routine is started at step 320. At step 322, the microprocessor 114 measures the sensor voltages VS3 and VS4, and at step 324, the microprocessor 114 calculates the width error WE using the formula: WE=VS4+VS3. In step 326, if WE is not equal to (or less than) a second predetermined minimum value MIN2, at step 328, the microprocessor 114 adjusts the control signal applied to the width control input of the deflection signal generator 106. The microprocessor 114 then repeats steps 322, 324, 326 and 328 until the width error WE is equal to (or less than) MIN2, and the sub-routine ends at 330. FIG. 5A shows the center adjust pattern offset too much to the right, while FIG. 5B shows the center adjust pattern in the correct position.

For controlling the height, step 220 in FIG. 6, as shown in FIG. 7C, the sub-routine starts at step 340, and at step 342, the microprocessor 114 measures the output voltages VS1 and VS2 of the sensors S1 and S2. At step 344, the microprocessor 114 calculates the height error HE using the formula: HE=VS2+VS1. If, at step 346, the height error is not less than (or equal to) a third predetermined minimum value MIN3, at step 348, the microprocessor 114 adjusts the control signal applied to the width control input of the deflection signal generator 106, and then repeats steps 342, 344, 346 and 348 until the height error HE is less than or equal to MIN3. The sub-routine then ends at step 350.

For controlling the linearity (i.e., the vertical centering of the raster), step 222 in FIG. 6, as shown in FIG. 7D, the sub-routine starts at step 360. At step 362, the microprocessor 114 measures the sensor voltages VS1 and VS2, and at step 364, the microprocessor 114 calculates the linearity error LE using the formula: LE=|VS2−VS1|. At step 366, if the linearity error LE is not less than or equal to a fourth predetermined minimum value MIN4, at step 368, the microprocessor 114 adjusts the control signal to the linearity control input of the deflection signal generator 106 and repeats steps 362, 364, 366 and 368, until the linearity error LE is less than or equal to MIN4. This sub-routine ends at step 370.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

What is claimed is:

1. A method for adjusting the centering of a raster in a rear projection television receiver, said method comprising the steps:
mounting optical sensors on the inside of the rear projection television receiver outside of a display screen at both lateral sides of the display screen;
displaying a test pattern consisting of a raster center adjust pattern; and
adjusting the centering of the raster based on the outputs of the optical sensors located on the lateral sides of the display screen.

2. The method for adjusting the centering as claimed in claim 1, wherein said adjusting step comprises:
setting a centering control at a one extreme value;
measuring the output voltages generated by the lateral optical sensors;
calculating the centering error by determining the absolute value of the difference between the output voltages;
incrementally adjusting the centering control away from said one extreme value; and
repeating said measuring, calculating and incrementally adjusting steps until the centering error is at a minimum value.

3. A method for adjusting a width of a raster in a rear projection television receiver, said method comprising the steps:
mounting optical sensors on the inside of the rear projection television receiver outside of a display screen at both lateral sides of the display screen;
displaying a test pattern consisting of a raster projection pattern; and
adjusting the width of the raster based on the outputs of the optical sensors located on the lateral sides of the display screen.

4. The method for adjusting a width as claimed in claim 3, wherein said adjusting step comprises:
setting a width control for the raster to a maximum value;
measuring the output voltages generated by the lateral optical sensors;
calculating the width error by determining the sum of the output voltages;
incrementally decreasing the width control; and
repeating said measuring, calculating and incrementally decreasing steps until the width error equals a minimum value.

5. A method for adjusting a linearity of a raster in a rear projection television receiver, said method comprising the steps:
mounting optical sensors on the inside of the rear projection television receiver outside of a display screen at the top and bottom of the display screen;
displaying a test pattern consisting of a raster projection pattern; and
adjusting the linearity of the raster based on the outputs of the optical sensors located at the top and bottom of the display screen.

6. The method for adjusting a linearity as claimed in claim 5, wherein said adjusting step comprises:
setting a linearity control to one extreme value;
measuring the output voltages generated by the top and bottom optical sensors;
calculating the linearity error by determining the absolute value of the difference of the output voltages;
incrementally adjusting the linearity control away from said one extreme value; and
repeating said measuring, calculating and incrementally adjusting steps until the linearity error equals a minimum value.

7. A method for adjusting a height of a raster in a rear projection television receiver, said method comprising the steps:
mounting optical sensors on the inside of the rear projection television receiver outside of a display screen at the top and bottom of the display screen;
displaying a test pattern consisting of a raster projection pattern; and
adjusting the height of the raster based on the outputs of the optical sensors located at the top and bottom of the display screen.

8. The method for adjusting a height as claimed in claim 7, wherein the adjusting step comprises:
setting a height control for the raster to a maximum value;
measuring the output voltages generated by the top and bottom optical sensors;
calculating the height error by determining the sum of the output voltages;
incrementally decreasing the height control; and
repeating said measuring, calculating and incrementally decreasing steps until the height error equals a minimum value.

9. A method for adjusting a raster geometry in a rear projection television receiver, said method comprising the steps:
mounting optical sensors on the inside of the rear projection television receiver outside of a display screen at both lateral sides and above and below the display screen;
setting the height and width controls for the raster to respective maximum values;
displaying a first test pattern consisting of a raster projection pattern;
measuring and storing the maximum output from said optical sensors;
displaying a second test pattern consisting of a center adjust pattern;
adjusting the centering of the raster based on the outputs of the optical sensors located on the lateral sides of the display screen;
displaying the first test pattern;
adjusting the width of the raster based on the outputs of the optical sensors located on the lateral sides of the display screen;
adjusting the height of the raster based on the outputs of the optical sensors located above and below the display screen;
adjusting the linearity of the raster based on the outputs of the optical sensors located above and below the display screen; and
re-adjusting the height of the raster based on the outputs of the optical sensors located above and below the display screen.

10. The method for adjusting the raster geometry as claimed in claim 9, wherein said step of adjusting the centering comprises:
setting a centering control at a one extreme value;
measuring the output voltages generated by the lateral optical sensors;
calculating the centering error by determining the absolute value of the difference between the output voltages;
incrementally adjusting the centering control away from said one extreme value; and
repeating said measuring, calculating and incrementally adjusting steps until the centering error is at a minimum value.

11. The method for adjusting the raster geometry as claimed in claim 10, wherein said step of adjusting the width comprises:
setting a width control for the raster to a maximum value;
measuring the output voltages generated by the lateral optical sensors;
calculating the width error by determining the sum of the output voltages;
incrementally decreasing the width control; and
repeating said measuring, calculating and incrementally decreasing steps until the width error equals a minimum value.

12. The method for adjusting the raster geometry as claimed in claim 11, wherein said step of adjusting the height comprises:
setting a height control for the raster to a maximum value;
measuring the output voltages generated by the top and bottom optical sensors;
calculating the height error by determining the sum of the output voltages;
incrementally decreasing the height control; and
repeating said measuring, calculating and incrementally decreasing steps until the height error equals a minimum value.

13. The method for adjusting the raster geometry as claimed in claim 12, wherein said step of adjusting the linearity comprises:
setting a linearity control to one extreme value;
measuring the output voltages generated by the top and bottom optical sensors;
calculating the linearity error by determining the absolute value of the difference of the output voltages;
incrementally adjusting the linearity control away from said one extreme value; and
repeating said measuring, calculating and incrementally adjusting steps until the linearity error equals a minimum value.

14. An arrangement for adjusting a raster geometry in a rear projection television receiver, said rear projection television receiver having an input for receiving television signals, a video processing circuit for processing said received television signals and for forming color video signals and deflection control signals, color video signal projectors for projecting light signals corresponding to said color video signals in dependence on said deflection signals, and a display screen on which said light signals are projected, wherein said video signal processing circuit includes control input means for receiving control signals for controlling a centering, height, width and linearity of a raster formed by at least one of said color video signal projectors, characterized in that said arrangement comprises:
a pattern generator coupled to the video signal processing circuit for applying selected test patterns to said video signal processing circuit, said test patterns including a center adjust pattern and a raster projection pattern;
a plurality of optical sensors mounted inside of the rear projection television receiver outside of the display screen at both lateral sides and above and below the display screen;
a sensor output selector for selecting an output signal from one of said plurality of optical sensors;
an analog-to-digital converter for digitally converting the selected optical sensor output signal;
a controller having an input coupled to receive the digitally converted sensor output signal, a first output coupled to said sensor output selector for selecting one of the sensor output signals, a second output coupled to the video signal processing circuit for causing the video signal processing circuit to process the test pattern from the pattern generator, a third output coupled to the pattern generator for selecting one of the test patterns, and fourth outputs coupled to the control input means of the video signal processing circuit for controlling the centering, height, width and linearity of the raster generated by said one color video signal projector, wherein said controller performs the following functions:
sets the height and width controls for the raster to respective maximum values;
displays a first test pattern consisting of a raster projection pattern;
measures and stores the maximum output from said optical sensors;
displays a second test pattern consisting of a center adjust pattern;
adjusts the centering of the raster based on the outputs of the optical sensors located on the lateral sides of the display screen;
displays the first test pattern;
adjusts the width of the raster based on the outputs of the optical sensors located on the lateral sides of the display screen;
adjusts the height of the raster based on the outputs of the optical sensors located above and below the display screen;
adjusts the linearity of the raster based on the outputs of the optical sensors located above and below the display screen; and
re-adjusts the height of the raster based on the outputs of the optical sensors located above and below the display screen.
